(19) United States
(12) Patent Application Publication
(10) Pub. No.: US 2013/0038567 A1
(43) Pub. Date: Feb. 14, 2013

(54) INPUT DEVICE WITH MULTIPLE LAYERS OF LUMINOUS PATTERNS

(71) Applicant: Chung-Yuan Chen, Taipei (TW)

(72) Inventor: Chung-Yuan Chen, Taipei (TW)

(73) Assignee: PRIMAX ELECTRONICS LTD., Taipei (TW)

(21) Appl. No.: 13/241,845

(22) Filed: Sep. 23, 2011

(30) Foreign Application Priority Data
Aug. 8, 2011 (TW) 100128200

(51) Int. Cl. G06F 3/044; G06F 3/041

(52) U.S. Cl. 345/174; 345/173

(57) ABSTRACT

An input device with multiple layers of luminous patterns is provided. The input device includes an input interface, a first light-emitting element, a first light-guiding plate, a second light-emitting element, and a second light-guiding plate. The first light-guiding plate has a plurality of first luminous patterns. The second light-guiding plate is located under the first light-guiding plate, and has a plurality of second luminous patterns. The first luminous patterns and the second luminous patterns are composed of light-guiding microstructures. The number of the light-guiding microstructures of the first luminous patterns is smaller than the number of the light-guiding microstructures of the second luminous patterns.

### FIELD OF THE INVENTION

The present invention relates to an input device, and more particularly to an input device with luminous patterns.

### BACKGROUND OF THE INVENTION

With increasing development of science and technology, various touch-sensitive input devices are introduced into the market. The touch-sensitive input device may be operated in two different input modes. In addition, the touch-sensitive input device has an illumination module. In a case that the illumination module is enabled, a preset pattern of the touch-sensitive input device is visible, and thus the touch-sensitive input device is operated in a first input mode. Whereas, in a case that the illumination module is disabled, the preset pattern is invisible, and thus the touch-sensitive input device is operated in a second input mode. That is, the user may realize the current input mode of the touch-sensitive input device by judging whether the preset pattern is visible or not. For example, if the illumination module is disabled, the whole outward appearance of the touch-sensitive input device looks black, and the input mode is a preset mouse cursor control mode. Under this circumstance, the user may perform a mouse-moving action or a clicking action by operating the whole black touch-sensitive input device. Whereas, if the illumination module is enabled, the touch-sensitive input device is shown as a luminous keyboard, and the input mode is a preset keyboard control mode. Under this circumstance, the user may input characters and symbols via the touch-sensitive input device according to the visible luminous pattern. For avoiding the user's confusion, the luminous touch-sensitive input device should be specially designed to make the preset pattern invisible when the illumination module is disabled and make the preset pattern visible when illumination module is enabled.

FIG. 1 is a schematic side view illustrating a conventional luminous input device. The conventional luminous input device 1 comprises an input interface 11, an illumination module 12 and a Mylar plate 13. From bottom to top, the input interface 11, the illumination module 12 and the Mylar plate 13 are sequentially shown. In a case that the input interface 11 is triggered by a user's finger or a pen, a corresponding touching signal is generated. The illumination module 12 comprises a light-emitting element 121 and a light-guiding plate 122. The light-emitting element 121 is used for emitting a first light beam (not shown). The light-guiding plate 122 is located beside the light-emitting element 121 for guiding the first light beam to the input interface 11. For example, the light-emitting element 121 is a light emitting diode (LED). The Mylar plate 13 has a plurality of luminous patterns 131. These luminous patterns 131 are disposed on a bottom surface 133 of the Mylar plate 13. In addition, the luminous patterns 131 are formed by printing a black light-shading ink having a light-shading percentage of about 98%. The regions of the bottom surface 133 of the Mylar plate 13 excluding the luminous patterns 131 are light-shading layers 132. These light-shading layers 132 are formed by printing a black opaque ink. Consequently, the light beam is only permitted to be transmitted through the regions of the bottom surface 133 of the Mylar plate 13 that are printed with the luminous patterns 131; and the light beam fails to be transmitted through the light-shading layers 132.

In a case that the illumination module 12 of the luminous input device 1 is disabled, the weak ambient light beam from the surroundings may be directed into the luminous input device 1. Since the luminous patterns 131 have the light-shading percentage of about 98%, only 2% of the ambient light beam can be transmitted through the luminous patterns 131. Since the ambient light beam is too weak, the luminous patterns 131 of the Mylar plate 13 fail to be recognized by naked eyes. In other words, the luminous patterns 131 are invisible. Whereas, when the illumination module 12 of the luminous input device 1 is enabled, a great portion of the first light beam is directed into the luminous input device 1. Although only 2% of the light beam from the illumination module 12 can be transmitted through the Mylar plate 13, the light intensity is sufficient to be recognized by the human's eyes. Under this circumstance, the luminous patterns 131 are visible, and thus the user can recognize the touched position corresponding to the luminous patterns 131 of the luminous input device 1. The configurations and functions of the conventional touch-sensitive input device have been illustrated as above.

With increasing development of science and technology, the functions of the touch-sensitive input device become more diverse. Nowadays, an input device with multiple layers of luminous patterns is introduced into the market. FIG. 2 is a schematic side view illustrating an input device with multiple layers of luminous patterns according to the prior art. As shown in FIG. 2, the input device 2 comprises an input interface 21, a first illumination module 22, a second illumination module 23, a circuit board 24 and a protective layer 25. From bottom to top, the input interface 21, the second illumination module 23, the first illumination module 22 and the protective layer 25 are sequentially shown.

The first illumination module 22 comprises a first light-emitting element 221 and a first light-guiding plate 222. The first light-emitting element 221 is used for emitting a first light beam (not shown). The first light-guiding plate 222 is located beside the first light-emitting element 221 for guiding the first light beam to the input interface 21. In addition, the first light-guiding plate 222 has a plurality of first luminous patterns 2221. The first luminous patterns 2221 are disposed on a bottom surface 2222 of the first light-guiding plate 222. That is, when the first light beam is emitted by the first light-emitting element 221, the first luminous patterns 2221 of the first light-guiding plate 222 are illuminated to be visible. Moreover, the first luminous patterns 2221 are collectively defined as an alphanumeric keyboard interface for inputting letters.

The second illumination module 23 comprises a second light-emitting element 231 and a second light-guiding plate 232. The second light-emitting element 231 is used for emitting a second light beam (not shown). The second light-guiding plate 232 is located beside the second light-emitting element 231 for guiding the second light beam to the input interface 21. In addition, the second light-guiding plate 232 has a plurality of second luminous patterns 2321. The second luminous patterns 2321 are disposed on a bottom surface 2322 of the second light-guiding plate 232. That is, when the second light beam is emitted by the second light-emitting element 231, the second luminous patterns 2321 of the second light-guiding plate 232 are illuminated to be visible. Moreover, the second luminous patterns 2321 are collectively defined as a Chinese keyboard interface for inputting Chinese characters. In addition, the light-emitting element 221 and the light-emitting element 231 are light emitting diodes.

Please refer to FIG. 2 again. The protective layer 25 is disposed over the first illumination module 22. The protective layer 25 is used for protecting the first illumination module 22 from being collided or rubbed by the external force. The protective layer 25 has a light-shading layer 251. The light-shading layer 251 is disposed over a top surface 252 of the protective layer 25 for shading a great portion of the first light beam, a great portion of the second light beam or a great portion of the external light beam. The light-shading layer 251 is formed by printing a light-shading ink on the top surface 252 of the protective layer 25. In addition, the light-shading layer 251 has a preset light-shading percentage of about 98%. The circuit board 24 is located beside the first illumination module 22 and the second illumination module 23. The first light-emitting element 221 and the second light-emitting element 231 are disposed on the circuit board 24. As shown in FIG. 2, the first light-emitting element 221 and the second light-emitting element 231 are front-view light emitting diodes.

In a case that the first illumination module 22 and the second illumination module 23 of the input device 2 are disabled, the weak ambient light beam from the surroundings may be directed into the luminous input device 2. Since the light-shading layer 251 has the preset light-shading percentage of about 98%, only 2% of the ambient light beam can be transmitted through the light-shading layer 251. Since the ambient light beam is too weak, the ambient light beam fails to be recognized by naked eyes. Consequently, the first luminous patterns 2221 and the second luminous patterns 2321 on the first light-guiding plate 222 and the second light-guiding plate 232 are invisible. That is, these luminous patterns are not viewed by the user. Whereas, when the first illumination module 22 of the input device 2 is enabled, a great portion of the first light beam is directed into the input device 2. Although only 2% of the light beam from the first illumination module 22 can be transmitted through the light-shading layer 251, the light intensity is sufficient to be recognized by the human's eyes. Under this circumstance, the first luminous patterns 2221 are visible, and thus the user can recognize the touched position corresponding to the first luminous patterns 2221 of the input device 2. The operations of enabling the second illumination module 23 of the input device 2 of this embodiment are similar to those of the first illumination module 22, and are not redundantly described herein.

In the conventional input device 2, the first luminous patterns 2221 of the first light-guiding plate 222 and the second luminous patterns 2321 of the second light-guiding plate 232 are arranged in a staggered form. Due to the staggered arrangement, the fraction of the second light beam passing through the upper-layered first luminous patterns will be reduced. Consequently, when the second illumination module 23 are enabled to make the second luminous patterns 2321 visible, the first luminous patterns 2221 that should be viewed are slightly visible.

As mentioned above, in the conventional input device, the first luminous patterns 2221 of the first light-guiding plate 222 and the second luminous patterns 2321 of the second light-guiding plate 232 are arranged in the staggered form in order to make the first luminous patterns slightly visible. However, since the conventional input device 2 has insufficient efficacy of the making the first luminous patterns 2221 invisible, the first luminous patterns 2221 can be viewed by the naked eyes of the user. Therefore, there is a need of providing an input device for minimizing the possibility of simultaneously making the multiple layers of luminous patterns visible.

### SUMMARY OF THE INVENTION

The present invention relates to an input device with multiple layers of luminous patterns, in which the possibility of simultaneously making the multiple layers of luminous patterns visible is minimized.

In accordance with an aspect of the present invention, there is provided an input device with multiple layers of luminous patterns. The input device includes an input interface, a first light-emitting element, a first light-guiding plate, a second light-emitting element, and a second light-guiding plate. When the input interface is triggered, a touching signal is generated. The first light-emitting element is used for emitting a first light beam. The first light-guiding plate is located beside the first light-emitting element and has a plurality of first luminous patterns for guiding the first light beam and making the first luminous patterns visible. The first luminous patterns are composed of M light-guiding microstructures. The second light-emitting element is disposed under the first light-emitting element for emitting a second light beam. The second light-guiding plate is located under the first light-guiding plate and beside the second light-emitting element and having a plurality of second luminous patterns for guiding the second light beam and making the second luminous patterns visible. The second luminous patterns are composed of N light-guiding microstructures or N light-guiding dots, wherein N is greater than M.

In an embodiment, the input device further includes a protective layer, which is disposed over the first light-guiding plate. The protective layer includes a light-shading zone and a light-transmissible zone. The light-shading zone is located around the light-transmissible zone for shading the first light beam or the second light beam. In response to the first light beam or the second light beam, the first luminous patterns or the second luminous patterns are visible through the light-transmissible zone.

In an embodiment, the light-transmissible zone contains a plurality of light-shading particles, so that the light-transmissible zone has a preset light-shading percentage. If the first light beam or the second light beam is not generated by the first light-emitting element or the second light-emitting element, the first luminous pattern or the second illumination module is invisible by the first light-guiding plate and the second light-guiding plate according to the preset light-shading percentage.

In an embodiment, if the first light beam or the second light beam is not generated, an external light beam from surroundings of the input device is blocked by the light-shading zone having the preset light-shading percentage, so that the first luminous pattern or the second luminous pattern is invisible. The preset light-shading percentage is in a range between 80% and 90%.

In an embodiment, the first light-emitting element and the second light-emitting element are both side-view light emitting diodes, and the protective layer is a glass plate or a plastic plate.

In an embodiment, the input interface is arranged between the protective layer, and the input interface is a light-transmissible surface capacitive touch sensor, a light-transmissible inner capacitive touch sensor or a light-transmissible projected capacitive touch sensor.

In an embodiment, the input device is disposed under the second light-guiding plate, and the input device is an opaque PCB capacitive touch sensor.

In an embodiment, the first luminous patterns are disposed on a top surface or a bottom surface of the first light-guiding plate, and the second luminous patterns are disposed on a top surface or a bottom surface of the second light-guiding plate.

In an embodiment, the input device further includes a circuit board, which is arranged between the first light-emitting element and the second light-emitting element. The first light-emitting element is disposed on a first surface of the circuit board, and the second light-emitting element is disposed on a second surface of the circuit board, wherein the first light-emitting element and the second light-emitting element are powered by the circuit board.

In an embodiment, the N light-guiding dots are formed on the second light-guiding plate by a printing technology.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional luminous input device;

FIG. 2 is a schematic side view illustrating an input device with multiple layers of luminous patterns according to the prior art;

FIG. 3 is a schematic side view illustrating an input device with multiple layers of luminous patterns according to a first embodiment of the present invention;

FIG. 4 is a schematic top view illustrating the input device with multiple layers of luminous patterns according to the first embodiment of the present invention, in which the first light-emitting element is turned on;

FIG. 5 is a schematic top view illustrating the input device with multiple layers of luminous patterns according to the first embodiment of the present invention, in which the second light-emitting element is turned on; and

FIG. 6 is a schematic side view illustrating an input device with multiple layers of luminous patterns according to a second embodiment of the present invention.

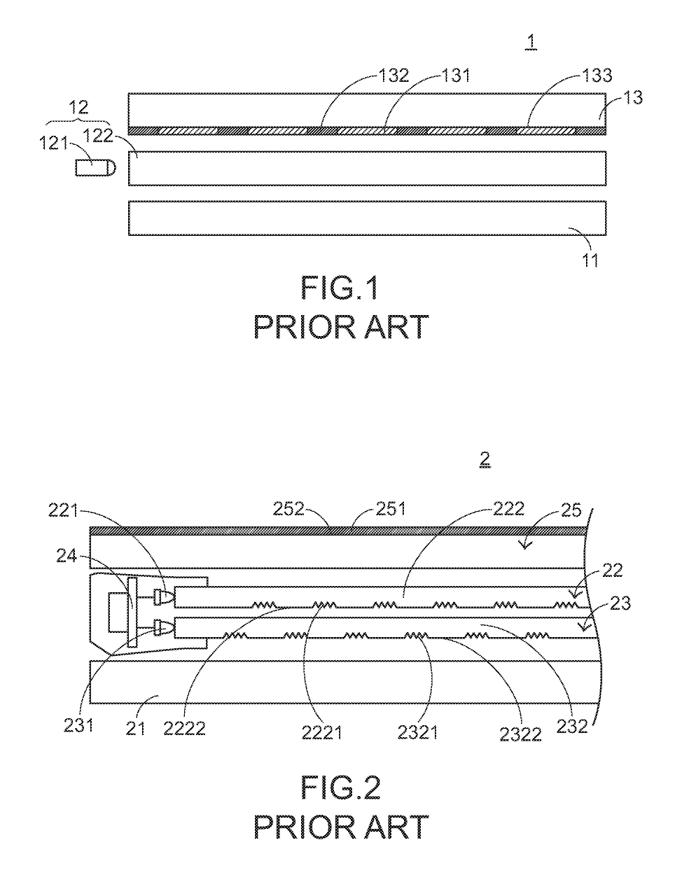

### DETAILED DESCRIPTION OF THE PREFERRED EMBODIMENT

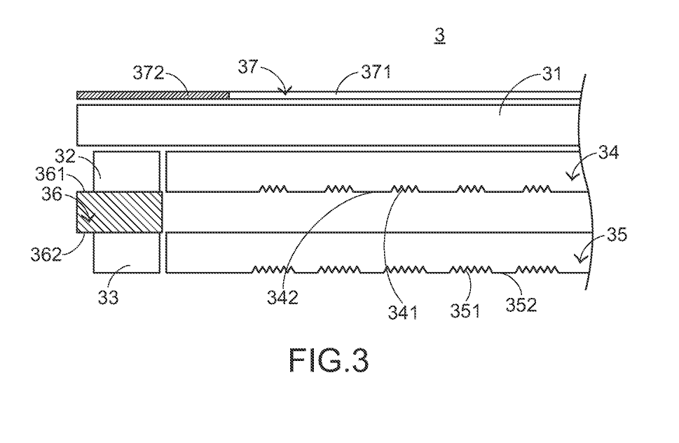

For obviating the drawbacks encountered from the prior art, the present invention provides an input device with multiple layers of luminous patterns. FIG. 3 is a schematic side view illustrating an input device with multiple layers of luminous patterns according to a first embodiment of the present invention. As shown in FIG. 3, the input device 3 comprises an input interface 31, a first light-emitting element 32, a second light-emitting element 33, a first light-guiding plate 34, a second light-guiding plate 35, a circuit board 36 and a protective layer 37. In a case that the input interface 31 is triggered by a user's finger or a pen, a corresponding touching signal is generated.

The first light-emitting element 32 is disposed on a first surface 361 of the circuit board 36. By acquiring electricity from the circuit board 36, the first light-emitting element 32 is powered to emit a first light beam (not shown). In this embodiment, the input interface 31 is light-transmissible surface capacitive touch sensor, and the first light-emitting element 32 is a side-view light emitting diode. The first light-guiding plate 34 is located beside the first light-emitting element 32 for guiding the first light beam to the input interface 31. In addition, the first light-guiding plate 34 has a plurality of first luminous patterns 341. The first luminous patterns 341 are disposed on a bottom surface 342 of the first light-guiding plate 34. That is, when the first light beam is emitted by the first light-emitting element 32, the first luminous patterns 341 of the first light-guiding plate 34 are visible.

The second light-emitting element 33 is disposed on a second surface 362 of the circuit board 36. By acquiring electricity from the circuit board 36, the second light-emitting element 33 is powered to emit a second light beam (not shown). The second light-emitting element 33 is also a side-view light emitting diode. The second light-guiding plate 35 is located beside the second light-emitting element 33 for guiding the second light beam to the input interface 31. In addition, the second light-guiding plate 35 has a plurality of second luminous patterns 351. The second luminous patterns 351 are disposed on a bottom surface 352 of the second light-guiding plate 35. That is, when the second light beam is emitted by the f second light-emitting element 33, the second luminous patterns 351 of the second light-guiding plate 35 are visible. In this embodiment, the first luminous patterns 341 are composed of M light-guiding microstructures (e.g. micro lenses or V-shaped notches), and the second luminous patterns 351 are composed of N light-guiding microstructures, wherein N is greater than M. That is, the number of the light-guiding microstructures of the first luminous patterns 341 is smaller than the number of the light-guiding microstructures of the second luminous patterns 351. The light-guiding microstructures for constituting the luminous patterns may change the incidence angles of the light beam within the first light-guiding plate 34 or the second light-guiding plate 35. Since the uses of the light-guiding microstructures can destroy the total internal reflection path, the light beam is refracted and transmitted through the first light-guiding plate 34 or the second light-guiding plate 35. That is, the light beam is transmitted through the regions over the light-guiding microstructures, so that the first luminous patterns 341 or the second luminous patterns 351 are visible.

In this embodiment, these first luminous patterns 341 are disposed on a bottom surface 342 of the first light-guiding plate 34. The second luminous patterns 351 are disposed on a bottom surface 352 of the second light-guiding plate 35. Alternatively, in some other embodiments, the first luminous patterns are disposed on a top surface of the first light-guiding plate, and the second luminous patterns are disposed on a top surface of the second light-guiding plate.

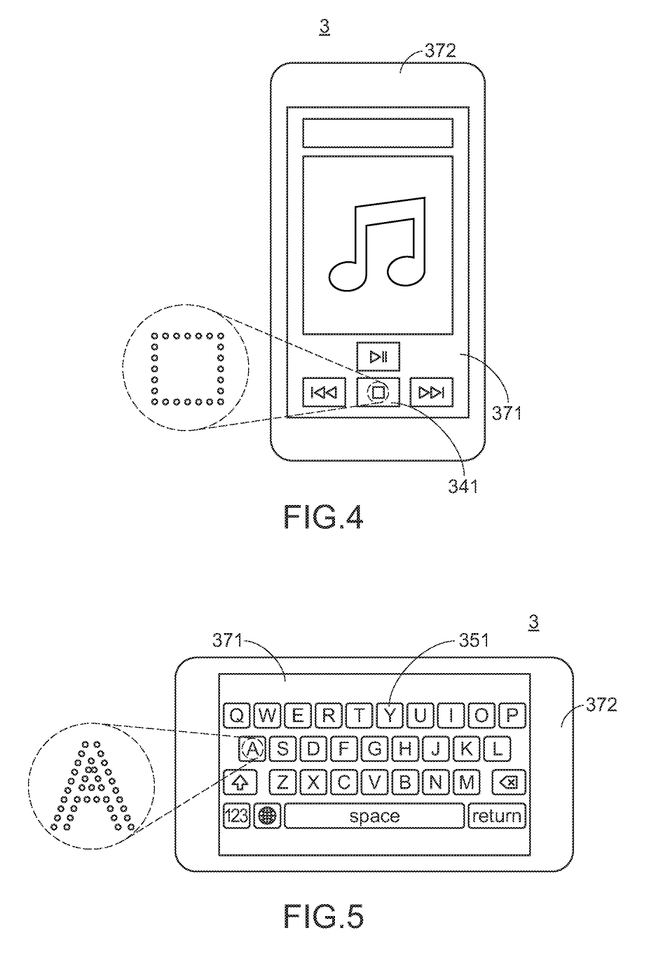

Please refer to FIG. 3 again. The protective layer 37 is located over the input interface 31 for protecting the input interface 31. In addition, the protective layer 37 comprises a light-transmissible zone 371 and a light-shading zone 372. The light-shading zone 372 is located around the light-transmissible zone 371 (see also FIG. 4). The light-shading zone 372 is used for shading the first light beam, the second light beam or the external light beam. In response to the first light beam or the second light beam, the first luminous patterns 341 or the second luminous patterns 341 are visible through the light-transmissible zone 371. Moreover, the light-transmissible zone 371 contains a plurality of light-shading particles, so that the light-transmissible zone 371 has a preset light-shading percentage. In this embodiment, the protective layer 37 is a glass plate or a plastic plate, and the preset light-shading percentage is in the range between 80% and 90%.

In a case that the first light-emitting element 32 and the second light-emitting element 33 are disabled and the first light beam and the second light beam are not generated, the first luminous patterns 341 and the second luminous patterns 351 are invisible by the first light-guiding plate 34 and the second light-guiding plate 35 according to the preset light-shading percentage. The reason will be illustrated as follows. If no light beam is emitted by the first light-emitting element 32 and the second light-emitting element 33, only the external light beam from the surroundings is possibly incident into the light-transmissible zone 371 of the protective layer 37. Since the preset light-shading percentage of the light-transmissible zone 371 is in the range between 80% and 90%, about 80-90% of the light beam incident into the light-transmissible zone 371 is absorbed by the light-transmissible zone 371. That is, the rest (i.e. 10-20%) of the light beam will be transmitted through the input interface 31 and directed to the first light-guiding plate 34. After the light-guiding microstructures on the bottom surface 342 of the first light-guiding plate 34 are hit by the rest (i.e. 10-20%) of the light beam, about a half of the light beam is refracted and continuously directed toward the region under the first light-guiding plate 34 because the incidence angles of the light beam projected on the light-guiding microstructures are different. That is, only about 10% of the light beam is reflected by the light-guiding microstructures and directed toward the input interface 31. After the light beam is reflected to the input interface 31, a portion of the light beam is absorbed by the light-transmissible zone 371 again. Meanwhile, only about 2% of the light beam is transmitted through the light-transmissible zone 371. Since the light beam intensity is too weak, the first luminous patterns 341 and the second luminous patterns 351 are invisible through the input interface 31. Under this circumstance, the first luminous patterns 341 and the second luminous patterns 351 fail to be viewed by the user.

FIG. 4 is a schematic top view illustrating the input device with multiple layers of luminous patterns according to the first embodiment of the present invention, in which the first light-emitting element is turned on. After the first light-emitting element 32 is turned on, a great portion of the first light beam is laterally incident into the first light-guiding plate 34. When the first light beam within the first light-guiding plate 34 is directed to the first luminous patterns 341 that are constructed by the light-guiding microstructures, the first light beam is directed toward the region over the first light-guiding plate 34 because the total internal reflection path is destroyed by the light-guiding microstructures. When the first light beam is transmitted through the input interface 31 and directed to the light-transmissible zone 371 of the protective layer 37, about 80-90% of the first light beam is absorbed by the light-transmissible zone 371. That is, about 10-20% of the first light beam is allowed to be transmitted through the light-transmissible zone 371, and the first luminous patterns 341 are visible through the input interface 31 and viewed by the user (see FIG. 4).

FIG. 5 is a schematic top view illustrating the input device with multiple layers of luminous patterns according to the first embodiment of the present invention, in which the second light-emitting element is turned on. After the second light-emitting element 33 is turned on, a great portion of the second light beam is laterally incident into the second light-guiding plate 35. When the second light beam within the second light-guiding plate 35 is directed to the second luminous patterns 351 that are constructed by the light-guiding microstructures, the second light beam is directed toward the region over the second light-guiding plate 35 because the total internal reflection path is destroyed by the light-guiding microstructures. Then, the second light beam is directed to the first light-guiding plate 34. Since the number (M) of the light-guiding microstructures of the first luminous patterns 341 is smaller than the number (N) of the light-guiding microstructures of the second luminous patterns 351, a great portion of the second light beam is directed to the input interface 31 through the first light-guiding plate 34 without passing through the light-guiding microstructures. That is, only a small portion of the second light beam is allowed to be transmitted through the light-guiding microstructures of the first light-guiding plate 34. The small portion of the second light beam passing through the light-guiding microstructures of the first light-guiding plate 34 is transmitted through the input interface 31, and directed to the protective layer 37 and absorbed by the light-transmissible zone 371. Of course, in a case that the light-transmissible zone 371 is not included in the input device 3, the small portion of the second light beam passing through the light-guiding microstructures of the first light-guiding plate 34 still fails to make the first luminous patterns 341 visible. When the second light beam not passing through the light-guiding microstructures is transmitted through the input interface 31 and directed to the light-transmissible zone 371 of the protective layer 37, about 80-90% of the second light beam is absorbed by the light-transmissible zone 371. That is, about 10-20% of the first light beam is allowed to be transmitted through the light-transmissible zone 371, and the second luminous patterns 351 are visible through the input interface 31 and viewed by the user, but the first luminous patterns 341 is invisible (see FIG. 5).

As shown in FIGS. 4 and 5, the first luminous patterns 341 are collectively defined as a music playback interface for controlling music playback, and the second luminous patterns 351 are collectively defined as an alphanumeric keyboard interface for inputting letters and symbols. From the profiles of the first luminous patterns 341 and the second luminous patterns 351 as shown in drawings, the number of the light-guiding microstructures of the first luminous patterns 341 is smaller than the number of the light-guiding microstructures of the second luminous patterns 351.

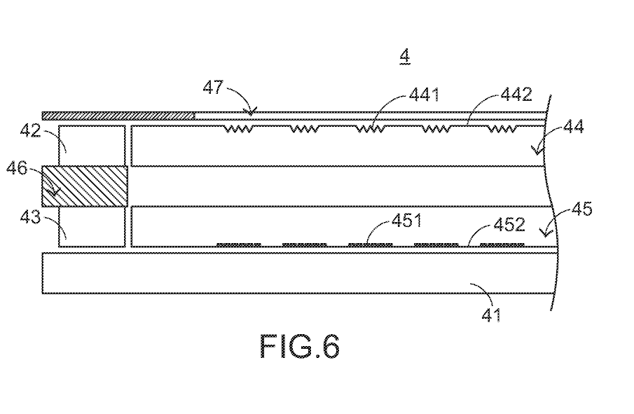

The present invention further provides a second embodiment. FIG. 6 is a schematic side view illustrating an input device with multiple layers of luminous patterns according to a second embodiment of the present invention. As shown in FIG. 6, the input device 4 comprises an input interface 41, a first light-emitting element 42, a second light-emitting element 43, a first light-guiding plate 44, a second light-guiding plate 45, a circuit board 46 and a protective layer 47. Except for the following three items, the configurations and functions of the input device of the second embodiment are similar to those of the first embodiment, and are not redundantly described herein. Firstly, the input device 41 is disposed under the second light-guiding plate 45, and the input device 41 is an opaque PCB capacitive touch sensor. Secondly, the first luminous patterns 441 are composed of M light-guiding microstructures, and the second luminous patterns 451 are composed of N light-guiding dots, wherein the N light-guiding dots are formed on the second light-guiding plate 45 by a printing technology. Thirdly, the first luminous patterns 441 of the first light-guiding plate 44 are disposed on a top surface 442 of the first light-guiding plate 44, and the second luminous patterns 451 of the second light-guiding plate 45 are disposed on a bottom surface 452 of the second light-guiding plate 45. The other components of the input device of the second embodiment are similar to those of the first embodiment, and are not redundantly described herein.

In this embodiment, the second luminous patterns under the first luminous patterns are composed of N light-guiding dots or N light-guiding microstructures. It is noted that the first luminous patterns can not be composed of light-guiding dots because the light-guiding dots are formed by a printing technology. If the first luminous patterns over the second luminous patterns are composed of the light-guiding dots, the underlying second light beam is possibly blocked by the light-guiding dots. Under this circumstance, the second luminous patterns to be visible fail to be effectively viewed.

In some other embodiments, the input interface is not limited to the light-transmissible surface capacitive touch sensor. For example, according to the practical requirements, a light-transmissible inner capacitive touch sensor or a light-transmissible projected capacitive touch sensor may be used as the input interface.

From the above description, the input device of the present invention has multiple layers of luminous patterns. Firstly, the number of the light-guiding microstructures on the first light-guiding plate and the number of the light-guiding microstructures on the second light-guiding plate are counted. The second light-guiding plate with more light-guiding microstructures is disposed under the first light-guiding plate. In such way, the fraction of the second light beam passing through the light-guiding microstructures of the first light-guiding plate from bottom to top will be reduced. The repeated experiments demonstrate that the input device of the present invention can reduce the efficacy of making the upper-layered first luminous patterns slightly visible. That is, the possibility of simultaneously making the multiple layers of luminous patterns visible will be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input device with multiple layers of luminous patterns, said input device comprising:
an input interface, wherein a touching signal is generated when said input interface is triggered;
a first light-emitting element for emitting a first light beam;
a first light-guiding plate located beside said first light-emitting element and having a plurality of first luminous patterns for guiding said first light beam and making said first luminous patterns visible, wherein said first luminous patterns are composed of M light-guiding microstructures;
a second light-emitting element disposed under said first light-emitting element for emitting a second light beam; and
a second light-guiding plate located under said first light-guiding plate and beside said second light-emitting element and having a plurality of second luminous patterns for guiding said second light beam and making said second luminous patterns visible, wherein said second luminous patterns are composed of N light-guiding microstructures or N light-guiding dots, wherein N is greater than M.

2. The input device according to claim 1 further comprising a protective layer, which is disposed over said first light-guiding plate, wherein said protective layer comprises a light-shading zone and a light-transmissible zone, and said light-shading zone is located around said light-transmissible zone for shading said first light beam or said second light beam, wherein in response to said first light beam or said second light beam, said first luminous patterns or said second luminous patterns are visible through said light-transmissible zone.

3. The input device according to claim 2 wherein said light-transmissible zone contains a plurality of light-shading particles, so that said light-transmissible zone has a preset light-shading percentage, wherein if said first light beam or said second light beam is not generated by said first light-emitting element or said second light-emitting element, said first luminous pattern or said second illumination module is invisible by said first light-guiding plate and said second light-guiding plate according to said preset light-shading percentage.

4. The input device according to claim 3 wherein if said first light beam or said second light beam is not generated, an external light beam from surroundings of said input device is blocked by said light-shading zone having said preset light-shading percentage, so that said first luminous pattern or said second luminous pattern is invisible, wherein said preset light-shading percentage is in a range between 80% and 90%.

5. The input device according to claim 2 wherein said first light-emitting element and said second light-emitting element are both side-view light emitting diodes, and said protective layer is a glass plate or a plastic plate.

6. The input device according to claim 2 wherein said input interface is arranged between said protective layer, and said input interface is a light-transmissible surface capacitive touch sensor, a light-transmissible inner capacitive touch sensor or a light-transmissible projected capacitive touch sensor.

7. The input device according to claim 2 wherein said input device is disposed under said second light-guiding plate, and said input device is an opaque PCB capacitive touch sensor.

8. The input device according to claim 1 wherein said first luminous patterns are disposed on a top surface or a bottom surface of said first light-guiding plate, and said second luminous patterns are disposed on a top surface or a bottom surface of said second light-guiding plate.

9. The input device according to claim 1 further comprising a circuit board, which is arranged between said first light-emitting element and said second light-emitting element, wherein said first light-emitting element is disposed on a first surface of said circuit board, and said second light-emitting element is disposed on a second surface of said circuit board, wherein said first light-emitting element and said second light-emitting element are powered by said circuit board.

10. The input device according to claim 1 wherein said N light-guiding dots are formed on said second light-guiding plate by a printing technology.
